(19) United States
(12) Patent Application Publication
(10) Pub. No.: US 2026/0320423 A1
(43) Pub. Date: Oct. 15, 2026

(54) GENERATING A FUZZY CAUSAL GRAPH USING AN ARTIFICIAL INTELLIGENCE SYSTEM

(71) Applicant: HSBC Global Services (UK) Limited, London (GB)

(72) Inventor: Philip David Harvey, Worcester Park (GB)

(21) Appl. No.: 19/467,593

(22) Filed: Feb. 2, 2026

(51) Int. Cl. G06N 5/022

(52) U.S. Cl. CPC G06N 5/022

(57) ABSTRACT

A graph generation system for generating a fuzzy causal graph is described. The graph generation system uses artificial intelligence to ingest and interpret source documents, such as regulations and internal policies, to automatically generate the fuzzy causal graph. This fuzzy causal graph represents concepts as nodes and their influence on one another as directed edges, with each edge labeled with a fuzzy term to describe the influence's strength. The generated fuzzy causal graph is validated through deterministic tests to ensure accuracy and reliability. The validated fuzzy causal graph can be queried to understand complex dependencies or used to run simulations to evaluate the impact of potential changes.

### BACKGROUND

In regulated fields such as banking, a core source of waste, toil, and regulatory risk stems from an inability to understand and act upon interlocked documentation. This documentation can include external regulations, legal specifications, internal controls, operating instructions, and architectural designs. The processes defined in these documents are often interdependent, yet organizations struggle to visualize the complex, cause-and-effect relationships between them. This lack of clarity creates inefficiency, rework, and compliance gaps. While existing automation tools can check for task completion, they cannot provide a queryable, system-wide view of the interlock landscape, preventing effective issue diagnosis and process improvement.

### SUMMARY

The present disclosure describes a system having a graph generation system that analyzes various documents and/or sources, such as regulations, controls, and design plans. Based on this analysis, the graph generation system automatically discovers and models complex, cause-and-effect relationships to create a machine-actionable fuzzy causal graph. Unlike a conventional knowledge graph that describes static facts, this fuzzy causal graph shows active influence. For example, the fuzzy causal graph represents concepts as nodes and their influence on one another as directed edges. Each edge is labeled with a fuzzy term (e.g., “none”, “some”, “much”, “a lot”, “all”) to describe the strength of the influence.

The graph generation system also includes a validation system that applies deterministic software tests to the generated fuzzy causal graph to ensure it is accurate and reliable. This validated fuzzy causal graph provides a trustworthy model of an organization's operations. Individuals can submit queries to the fuzzy causal graph to understand complex dependencies using a computational method for evaluating fuzzy relationships and/or run simulations to evaluate the impact of potential changes. This capability allows organizations to identify high-leverage improvements, helping to reduce risk and cost, and provides a testable, data-driven approach to managing organizational interlocks.

The fuzzy terms are placed on an ordered scale, which allows their strengths to be compared and calculated. For example, along a causal path, the system finds the minimum strength to identify the weakest link. Across several paths, it finds the maximum strength to identify the strongest influence. This provides a repeatable way to calculate the net influence from plain language.

Accordingly, examples of the present disclosure describe a method that includes receiving, by a computer system, source information from one or more sources. In response to receiving the source information, an artificial intelligence system associated with computer system generates a fuzzy causal graph from the source information. In an example, the fuzzy causal graph includes a plurality of nodes that represent concepts and a plurality of directed edges connecting the plurality of nodes. In an example, each directed edge represents an influence and is labeled with a fuzzy term that indicates a strength of the influence. The fuzzy causal graph is stored in a storage system. In response to receiving a query, the query is executed on the fuzzy causal graph to determine a net influence between at least two nodes of the plurality of nodes.

Other examples describe a system that includes one or more processors and a memory storing instructions that, when executed by the one or more processors, cause the system to perform operations. In an example, the operations include receiving source information from one or more sources. An artificial intelligence system associated with the system generates a fuzzy causal graph from the source information. In an example, the fuzzy causal graph includes a plurality of nodes that represent concepts. The fuzzy causal graph also includes a plurality of directed edges that connect the plurality of nodes. In an example, each directed edge represents an influence and is labeled with a fuzzy term that indicates a strength of the influence. The fuzzy causal graph is stored and may be queried. In response to receiving a query, the query is executed on the fuzzy causal graph to determine a net influence between at least two nodes of the plurality of nodes.

Still other examples describe a non-transitory computer-readable medium storing instructions that, when executed by one or more processors of a computer system, cause the computer system to perform operations. In an example, the operations include receiving source information from one or more sources and generating, by an artificial intelligence system, a fuzzy causal graph from the source information. In an example, the fuzzy causal graph includes a plurality of nodes that represent concepts and a plurality of directed edges connecting the plurality of nodes. In an example, each directed edge represents an influence and is labeled with a fuzzy term that indicates a strength of the influence.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a graph generation system according to an example.

FIG. 2 illustrates a method for identifying concepts and terms within one or more sources and generating a fuzzy causal graph based on the concepts and terms according to an example.

FIG. 3 illustrates a fuzzy causal graph that is generated by an artificial intelligence system according to an example.

FIG. 4A illustrates a query being submitted to the graph generation system of FIG. 1 according to an example.

FIG. 4B illustrates results from a query being returned to a computing device according to an example.

FIG. 4C illustrates how the graph generation system receives a hypothetical change from a computing device according to an example.

FIG. 5 illustrates a method for querying a fuzzy causal graph according to an example.

FIG. 6 illustrates a method for performing a simulation on a fuzzy causal graph according to an example.

FIG. 7 illustrates various components and/or systems of a computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

The present disclosure describes a system and method for automatically discovering and modeling complex interdependencies within an organization's documents and processes. The system uses artificial intelligence, particularly generative artificial intelligence systems and models, to analyze various sources such as regulations, internal controls, and design documents. From this analysis, the system constructs a model of cause-and-effect relationships, represented as an influence graph. This automated approach helps organizations understand hidden connections, reduce inefficiency, and manage risk more effectively.

The influence graph described herein is a “fuzzy causal graph.” Unlike a conventional knowledge graph that describes static relationships (e.g., “X is a Y”), a fuzzy causal graph models active influence (e.g., “X causes Y”) and supports simulation and queries that evaluate fuzzy relationships. The “fuzzy” aspect means that the strength of the influence is described with computable but non-numeric terms (e.g., "none", “some”, “much", “a lot”, "all"). These fuzzy terms are mapped to a predefined scale, giving them a mathematical order. This allows their values to be compared and used in calculations, such as finding a minimum or maximum strength. This approach allows the artificial intelligence system to more accurately capture the nuanced language found in source documents. This enables creation of a more robust and testable fuzzy causal graph. The fuzzy causal graph can also represent feedback loops (i.e., causal cycles), reflecting the dynamics of real-world systems.

The system uses a computational method to evaluate these fuzzy relationships, ensuring all calculations are repeatable. The vocabulary of fuzzy terms is placed on a fixed, ordered scale from least to greatest influence. For example, "none" has less influence than "some," which has less than "much," "a lot," and "all." This ordered scale provides the mathematical basis for the system's calculations.

To find the influence along a single causal path, the system identifies the minimum fuzzy strength. This reflects that a path is only as strong as its weakest link. When multiple paths exist between two concepts, the system identifies the maximum strength to show the strongest available route of influence. This method allows the system to evaluate natural language inputs in a repeatable way.

The overall process involves several stages. For example, the graph generation system ingests documents from various sources. An artificial intelligence system parses the documents to extract causal relationships and builds the fuzzy causal graph. The resulting fuzzy causal graph is stored and then validated to ensure its quality and consistency. Once created and stored, individuals can query the validated fuzzy causal graph to ask questions about system interlocks or run simulations to test the impact of potential changes. This enables data-driven decision-making to improve processes and reduce costs.

Accordingly, many technical benefits may be realized including, but not limited to, capturing nuanced, non-numeric language of influence found in real-world documents with greater accuracy than rigid statistical models. In addition, the fuzzy causal graph is machine-actionable and can be deterministically validated through various tests thereby creating a trustworthy and governable model of an organization's processes. This validated model serves as a foundation for a query system that uses a computational method for evaluating fuzzy relationships or other tools to uncover complex interdependencies. A simulation system allows users to evaluate the impact of hypothetical changes, thereby enabling data-driven process improvement and risk management.

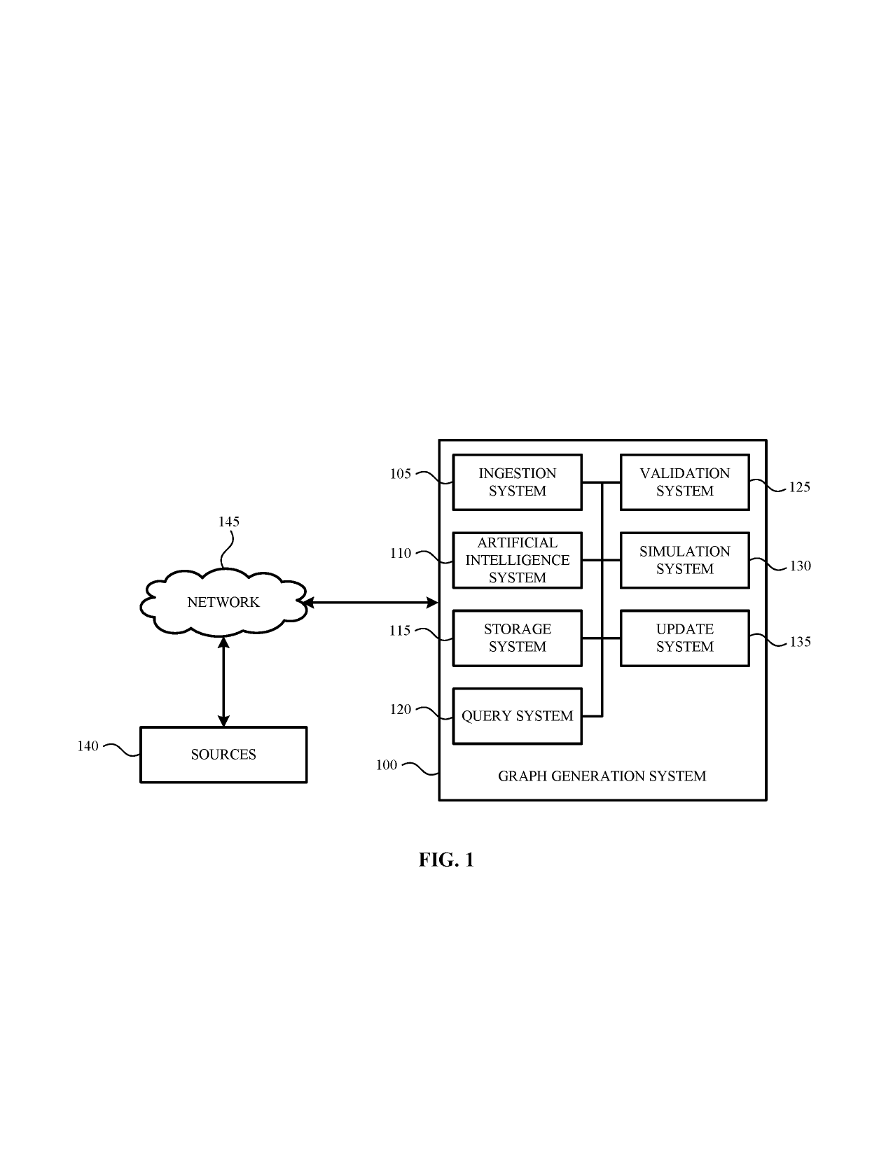

These and other examples will be shown and described in greater detail with respect to FIGS. 1 - 7.

FIG. 1 is a block diagram of a graph generation system 100. The graph generation system 100 includes an ingestion system 105, an artificial intelligence system 110, a storage system 115, a query system 120, a validation system 125, a simulation system 130, and an update system 135. The graph generation system 100 is in communication with one or more sources 140 over a network. Although a network is specifically mentioned, any other communication channel or medium is contemplated.

The ingestion system 105 gathers information from one or more sources 140. The external sources 140 can include a wide variety of structured and unstructured content, such as regulatory publications, internal control documentation, operating instructions, and solution designs. The ingestion system 105 retrieves this content via automated connectors (e.g., HTTP requests, API calls, web scraping, file uploads, or FTP) and deposits it into secure storage (e.g., the storage system 115). In some examples, the sources are converted into a representation that is readable/understandable by the artificial intelligence system 110.

The ingestion system 105 may also compute or determine usage metrics, assign priority scores to documents or chunks of documents, and determine indexing actions. This process supports later retrieval and context composition for LLM prompts during both interpretation and query answering.

The artificial intelligence system 110 receives the information from the ingestion system 105 and uses a large language model (LLM) to interpret the information. For example, the artificial intelligence system 110 identifies candidate nodes corresponding to concepts (e.g., regulations, controls, processes) and proposes directed edges between them. In an example, the artificial intelligence system 110 detects linguistic and structural cues of influence (e.g., “requires," "mandates," "drives," "enables," "limits," "depends on," "mitigates," "causes," "leads to," and "results in") and labels each proposed edge with a fuzzy term from a predefined vocabulary (e.g., "none", "some", "much", "a lot", "all"). For each proposed edge, the artificial intelligence system 110 also captures evidence from the sources 140 to support later validation.

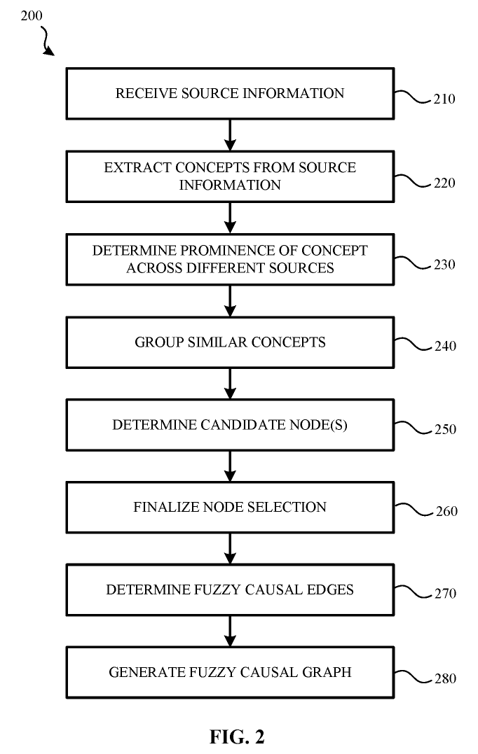

For example, and referring to FIG. 2, FIG. 2 illustrates a method 200 for identifying concepts and terms within one or more sources and generating a fuzzy causal graph based on the concepts and terms according to an example. In an example, the method 200 is executed by an artificial intelligence system of a graph generation system, such as, for example, the artificial intelligence system 110 of the graph generation system 100 shown and described with respect to FIG. 1.

In an example, the method 200 begins when the artificial intelligence system receives (210) source information. In an example, the source information includes content/data associated with various sources that were received, extracted and/or otherwise prepared by an ingestion system such as, for example, the ingestion system 105 (FIG. 1).

In response to receiving the source information, the artificial intelligence extracts (220) various concepts from the source information. For example, the artificial intelligence system reads sections, paragraphs, sentences, tables, lists, captions, and figure labels of the source information. The artificial intelligence system may also read or determine other information associated with the source information. This information includes, but is not limited to, metadata such as document class, effective dates, and jurisdiction and other similar types of information.

The artificial intelligence system may also target various concepts contained in the source information. These concepts include, but are not limited to, regulations, controls, processes, systems, data classes, teams, risks, and metrics. Although specific concepts are mentioned, other concepts are contemplated. In an example, and as part of the extraction operation, each detected mention is assigned a tentative type and an associated confidence value.

The extraction process may also include other operations including performing named-entity recognition to detect domain entities and regulatory citations, capturing multi-word terms and definitions, and using domain patterns to detect catalog IDs, clause markers, and control identifiers. The artificial intelligence system may also normalize and standardize the information. This may include making all of the information uniform (e.g., making all information lowercase, removing abbreviations, etc.) while preserving identifiers. The extraction process may also include generating a confidence score associated the information as the information is extracted from the sources.

The artificial intelligence system may also mark or identify a location at which the concepts are mentioned. For example, concepts that are mentioned in a title, in a heading, in a definition section and/or in a requirements section of the sources may be given more weight when compared to concepts in other portions of the sources.

The artificial intelligence system also determines (230) the prominence of concepts that are mentioned and/or contained in the different sources. In an example, the artificial intelligence system identifies and/or explains why a concept is highly ranked. In an example, the prominence of a concept is based, at least in part, on a number of times the concept is mentioned. In some examples, and as previously described, the location (e.g., whether the concept was mentioned in a title, in a header, in boilerplate language, etc.) may be taken into account when determining the prominence of the concept so repeated terms or concepts do not artificially inflate the prominence of a given concept.

In an example, the artificial intelligence system determines how often a concept appears within a section and the whole document. This may be normalized by a length of the document or section. The artificial intelligence system may also consider (as previously described) a structural prominence of the concept. For example, the artificial intelligence system determines whether the concept appearance in titles, headings, captions, and other high profile locations. The artificial intelligence system may also consider if/how terms associated with the concept are formatted. For example, concepts that are in bold, italicized, all capital etc., may be more important that other concepts. The artificial intelligence system may also consider how quickly a concept in mentioned in the document when determining its prominence. For example, concepts that are mentioned early in a document, such as a summary, may weigh more than concepts in an appendix.

Once identified, the concepts are grouped 240. In an example, the concepts are grouped by semantic similarity. In an example, the artificial intelligence system uses several signals to determine similarity. These include sentence-level and phrase-level embeddings for semantic closeness, string similarity for near-duplicates, and type constraints to prevent incorrect merges. The artificial intelligence system may also uses cross-document hints, such as identical control IDs or citation numbers, as strong indicators to merge concepts. The output of this step is a set of preliminary clusters, each containing its member mentions and a coherence score.

The artificial intelligence system then determines (250) candidate nodes of the identified concepts. For example, the artificial intelligence system take each group of similar mentions and/or concepts and generates or proposes a node. In an example, although the node has one official identifier (or name), it may be associated with other topics and/or names (e.g., those having a semantic similarity).

In an example, the node’s main label is selected from the most authoritative source first. Examples include a statute title or a control ID with its official name. If no authoritative form exists, the most common or prominent name of the concept is used. As discussed, the main label may also include other topics and/or names such as synonyms, abbreviations, and close variants as these can help match future mentions and improve subsequent searches. To further strengthen (or weaken) the determination that a concept should be a candidate node, the artificial intelligence system tracks where the evidence comes from. For example, the artificial intelligence system counts how many documents, sections, and/or sources support the concept identified as a candidate node.

The artificial intelligence system may then finalize (260) node selection. In an example, this includes deduplicating nodes by merging duplicate node candidates that either share strong identifiers (e.g., identical control IDs or regulation citations) or surpass a high similarity threshold. In an example, merges may also be based on evidence overlap, such that candidates are combined only where supporting excerpts originate from substantially the same sections or highly similar paraphrases across sources.

The artificial intelligence system may also apply one or more quality control measures to help ensure edges can be determined and that the concepts are validated and reliable. For example, the artificial intelligence system confirms that all mentions within a node share the same concept type, performs outlier detection, and conducts evidence bundling (e.g., attaching minimal, verifiable content such as, sentences, table cells, or figure captions, with other information and source document identifiers. Nodes that pass are output as validated node candidates.

The artificial intelligence system 110 then generates or determines (270) fuzzy causal edges that will be used to connect the nodes. In an example, a fuzzy causal edge is an influence link between nodes. These edges are labeled with a fuzzy strength from a predefined vocabulary (e.g., "none", "some", "much", "a lot", "all") and optionally annotated with polarity (positive/negative), conditions, evidence, and confidence.

In an example, the generation of edges includes scanning sentences and nearby sentences for influence cues. For example, the artificial intelligence system looks for verbs and phrases that imply causation or dependency. Examples include phrases like “requires,” “mandates,” “enables,” “limits,” “depends on,” “mitigates,” “causes,” “leads to,” and “results in.” Although specific examples are given, these are for example purposes only.

The artificial intelligence system may also detect policy cues such as “must,” “shall,” “should,” and “may.” Structural cues such as cross-references, mappings, and architectural dependencies are also considered as are diagram arrows and labeled connectors.

For each detected cue, the artificial intelligence system 110 extracts who influences whom. It identifies the source phrase and the target phrase. It resolves pronouns and cross-sentence references. It maps both phrases to the nearest canonical nodes using embeddings and type constraints. Using all of this information, the artificial intelligence system 110 outputs a directed candidate edge from the source node to the target node.

As part of this process, the artificial intelligence system also determines a polarity and direction of each edge. In an example, positive means the source enables or increases the target. Negative means the source inhibits or reduces the target. If negative influence is present, the system tracks positive and negative contributions separately using the same operators and then resolves the result according to predefined rules, such as selecting the dominant magnitude or applying a deterministic tie-break. This keeps sign handling clear and reproducible.

The artificial intelligence system may also extract scope and conditions for each edge. It may also record qualifiers such as jurisdiction, environment, or a team. The artificial intelligence system may also capture conditional phrases such as “if”, “when”, or “except”. It notes applicability and frequency terms such as “always”, “often”, or “periodically”. These attributes travel with the edge and can adjust effective strength when a query is received.

The artificial intelligence system 110 estimates the fuzzy strength of each candidate edge. It collects features that signal strength, including modal intensity, lexical intensity, quantifiers, structural authority, directness, multiplicity of evidence, proximity, and past reliability. It transforms these features into a fuzzy label chosen from ("none", "some", "much", "a lot", "all"). It also produces a numeric support score for traceability.

The artificial intelligence system also assigns an confidence score to each edge. In an example, the confidence score indicates a probability, an evidence quality, an agreement across sources, and/or a stability of the edge/node. The score may be based on evidence that is linked to the edge. The score may also be associated with text snippets, offsets, document identifiers, page or figure references, cue tokens, and parse fragments, etc., which enables later audit and deterministic re-checking of the fuzzy causal graph.

The artificial intelligence system then associates edges with the various nodes to generate (280) the fuzzy causal graph. As will be explained in detail below, the fuzzy causal graph may be queried to analyze or determine potential changes to one or more structures, policies, regulations, etc. represented by the fuzzy causal graph.

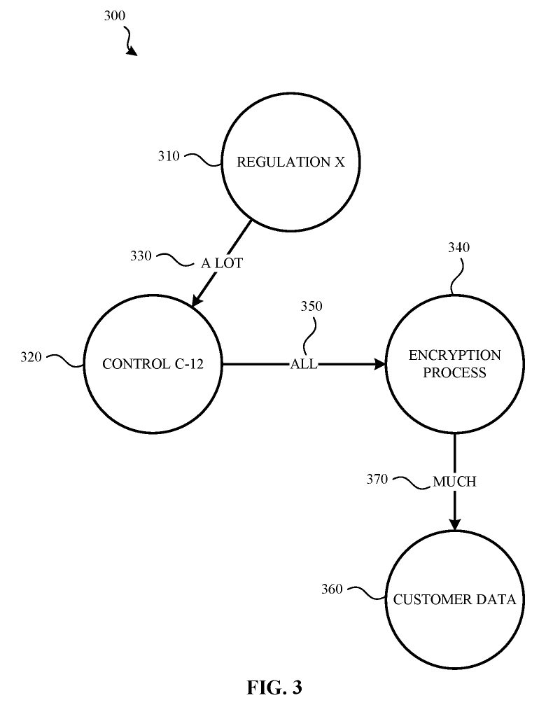

For example, and as previously explained, because edges are fuzzy (e.g., "none", "some", "much", "a lot", "all"), the graph generation system can map nuanced, real-world policy and design language into a computable structure suitable for validation, query, and simulation. For example, and referring to FIG. 3, FIG. 3 illustrates a fuzzy causal graph 300 that is generated by an artificial intelligence system according to an example. As shown in FIG. 3, the artificial intelligence system has identified the following nodes: Regulation X 310; Control C-12 320; Encryption Process 340; and Customer Data 360. As also shown in FIG. 3, the fuzzy causal edge 330 between Regulation X 310 and Control C-12 320 is “a lot”, suggesting that regulation is strongly associated with, or drives, the control.

Likewise, the fuzzy causal edge 350 between the Control C-12 320 and the Encryption Process 340 is “all”, suggesting that the control requires or mandates encryption. Additionally, the fuzzy causal edge 370 between the encryption process 340 and the customer data 360 is “much”, suggesting that encryption helps ensure the protection of the customer data.

Referring back to FIG. 1, once the fuzzy causal graph (e.g., the fuzzy causal graph 300 (FIG. 3)) has been generated, the fuzzy causal graph is sent to a storage system 115. Once stored, the fuzzy causal graph can be validated and subsequently queried.

For example, the validation system 125 applies one or more deterministic checks to the fuzzy causal graph to ensure it is a reliable and trustworthy model. In an example, these tests include ensuring repeatable query integrity (i.e., the same query yields the same result), fulfillment of known interlocks, conformance to curated test cases, and detection of gaps or inconsistencies. Because the fuzzy causal graph can contain cycles, the validation system 125 also enforces cycle-aware stopping conditions for queries. Edges that pass all tests are promoted to a validated status, while those that fail are marked or otherwise identified for review. This creates a closed-loop process that improves the quality of the fuzzy causal graph over time.

The query system 120 allows a user of the graph generation system 100 to access the validated fuzzy causal graph. Users can submit plain-text queries which are mapped to concepts in the fuzzy causal graph. The query system 120 resolves the net influence between concepts by computing path strength by taking the minimum edge strength along each path, then computing net influence by taking the maximum across all paths. Because the fuzzy terms are ordered and the operators are fixed, results are deterministic and repeatable. The query system 120 returns ranked influences with justifications based on the stored evidence, allowing users to locate sources of issues and high-leverage change points.

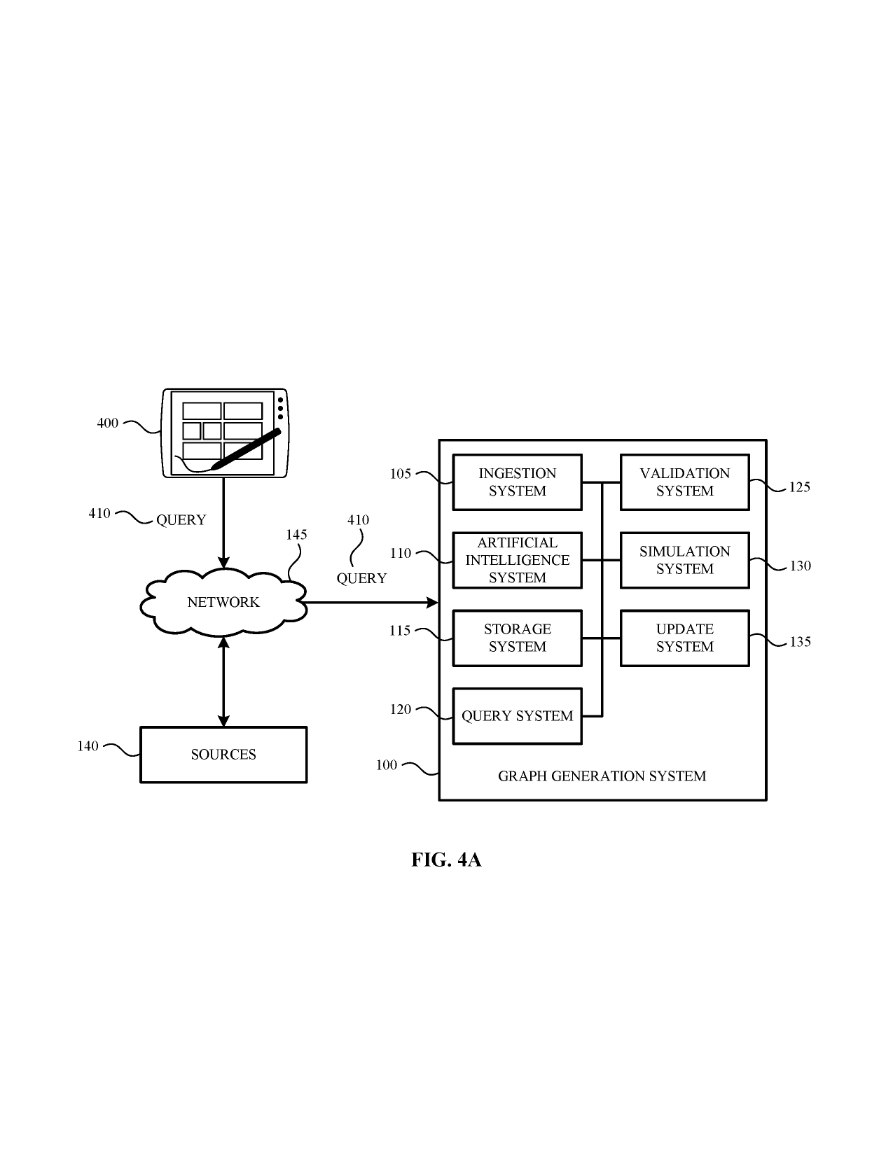

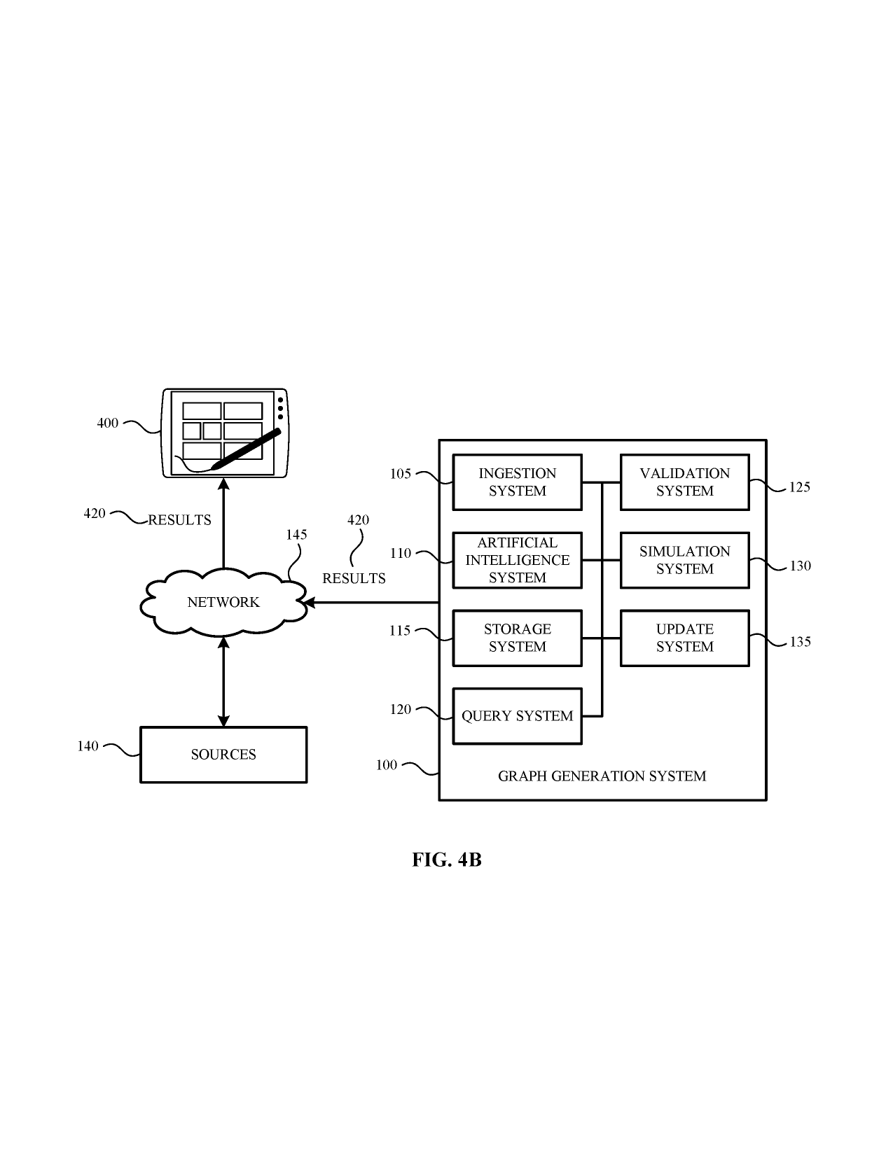

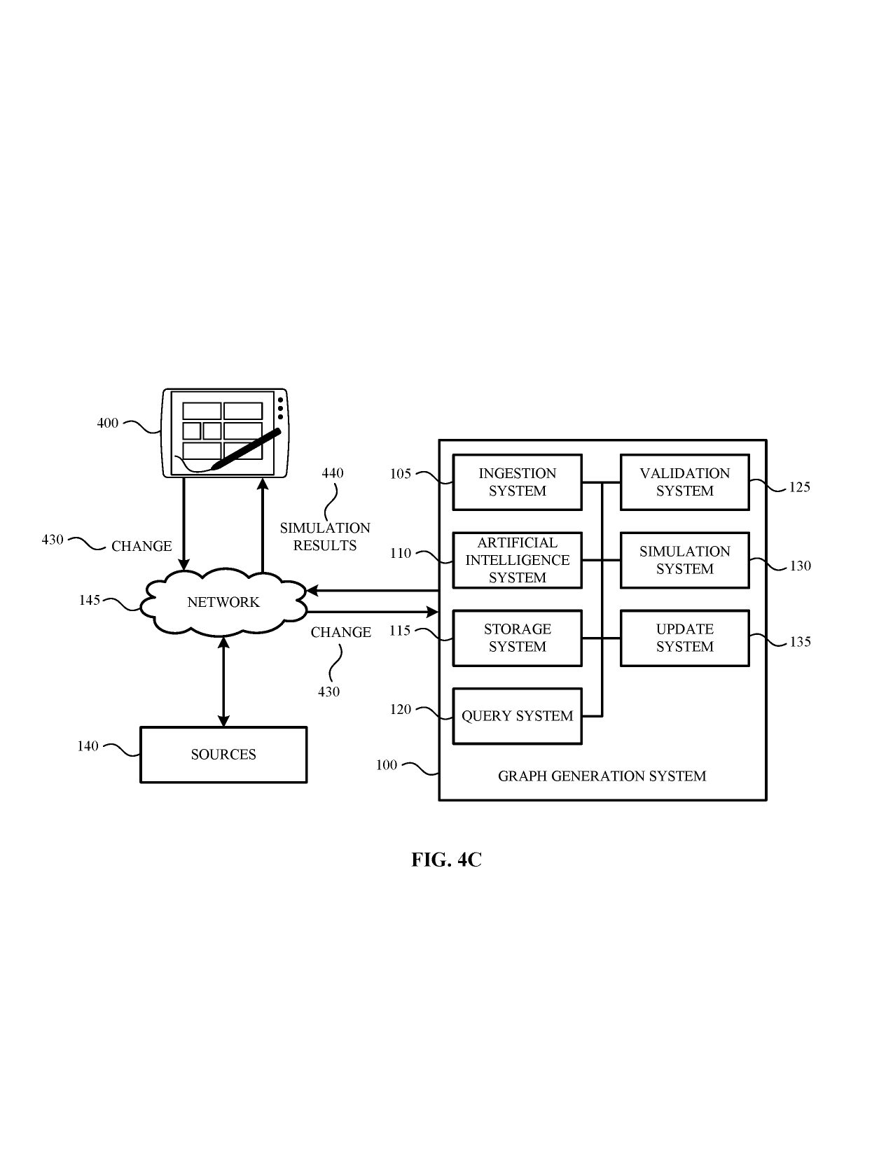

For example, and referring to FIG. 4A, FIG. 4A illustrates a query 410 being submitted to the graph generation system 100 of FIG. 1 according to an example. As shown, an individual, using a computing device 400 can submit the query 410 to the graph generation system 100 via the network 145 or other communication channel. In response to receiving the query 410, the graph generation system 100 provides the query 410 to the query system 120. The query system 120 analyzes the query and maps the query to corresponding concepts, or nodes, in the fuzzy causal graph.

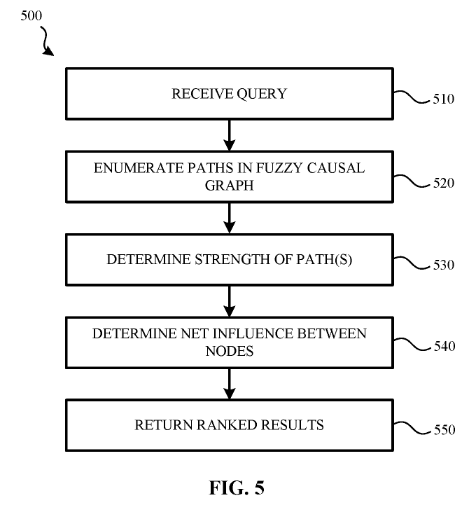

For example, and referring to FIG. 5, FIG. 5 illustrates a method 500 for querying a fuzzy causal graph according to an example. In an example, the method 500 is performed by a query system of a graph generation system, such as, for example, the query system 120 shown and described with respect to FIGS. 4A and/or 1.

In an example, the method 500 begins when a query is received (510). When the query is received, the query system analyzes the query to identify key entities and understand the intent of the query. For example, the query system determines whether the query is asking for influence on a concept, from a concept, or between two concepts. Phrases in the query are mapped to their corresponding nodes within the fuzzy causal graph, which serve as the starting and ending points for the influence calculation.

The query system enumerates (520) all possible paths in the fuzzy causal graph between the concepts of interest identified by, or associated with, the query. In an example, a path is a sequence of connected nodes and edges that represents a chain of influence. The query system traverses the fuzzy causal graph to identify every unique route from the starting concept(s) to the target concept(s).

For each enumerated path, the query system determines (530) the path's causal strength. The causal strength is determined by taking the minimum fuzzy strength from all the individual edges that constitute that path, a comparison made possible by the pre-defined rank of the fuzzy terms.

The net influence between the start node and the end node is then determined (540). For example, and after the strength for each individual path is calculated, the query system determines the final net influence between the start and end nodes by taking the maximum strength from the set of all parallel paths identified in operation 530, a comparison which is also based on the pre-defined rank of the fuzzy terms. As a result, the total influence is defined by the strongest single causal chain among all path possibilities.

The query system then returns (550) a ranked list of influences as results. For example, and referring to FIG. 4B, FIG. 4B illustrates results 420 from a query being returned to a computing device 400 according to an example. In an example, the results 420 presents the causal paths in order of their calculated strength, from strongest to weakest. For each path, the query system 120 provides supporting justifications derived from the evidence stored with each edge. This allows an individual to understand the reasoning behind the calculated influence and trace it back to the source documents.

The following is an example of a query as it relates to the fuzzy causal graph 300 shown in FIG. 3. An individual may submit a query to the query system 120, such as, “What is the net influence of Regulation X 310 on Customer Data 360?”. In response, the query system 120 identifies one path from Regulation X 310 to Customer Data 360: Regulation X 310 → Control C-12 320 → Encryption Process 340 → Customer Data 360. To calculate the net influence, the query system 120 determines the strength of the path by taking the minimum fuzzy strength of all edges along the path. Based on a pre-defined ranking (e.g., where "much" is less than "a lot"), the result is min("a lot", "all", "much") = "much". The query system 120 then returns a result indicating that the net influence is "much".

The simulation system 130 can then evaluate hypothetical changes to the fuzzy causal graph 300. For example, as shown in FIG. 4C, a user could submit a hypothetical change 430 to improve the encryption process, modeled by increasing the strength of the fuzzy causal edge 370 between the Encryption Process 340 and Customer Data 360 from "much" to "all". The simulation system 130 runs a simulation and re-evaluates the net influence of Regulation X 310 on Customer Data 360 in a modified fuzzy causal graph. The new path strength becomes min("a lot", "all", "all") = "a lot". The simulation results 440 would show that the proposed change increases the net influence from "much" to "a lot", allowing the user to make a data-driven decision.

In an example, the update system 135 maintains the fuzzy causal graph over time. The update system 135 monitors for changes in the external sources 140 (e.g., new regulations, revised controls) and triggers selective re-ingestion, re-interpretation, and re-validation. This process maintains a versioned, up-to-date fuzzy causal graph state, ensuring that query and simulation results remain reliable.

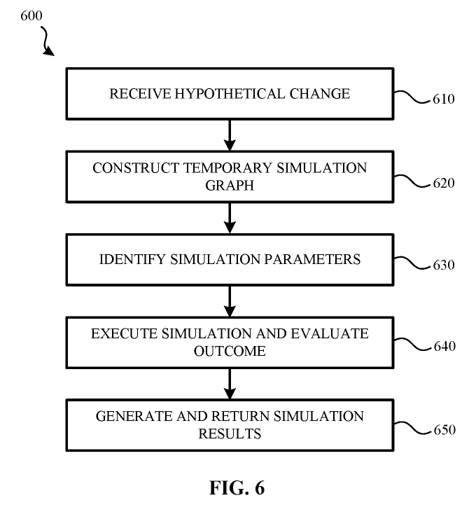

FIG. 6 illustrates a method 600 for performing a simulation on a fuzzy causal graph according to an example. In an example, the method 600 is performed by a simulation system, such as, for example, the simulation system 130 shown and described with respect to FIG. 1. The method 600 allows an individual to model and evaluate the impact of hypothetical “what-if” changes to the fuzzy causal graph before implementing them.

In an example, the method 600 begins when a hypothetical change is received (610) by the simulation system. In an example, the hypothetical change is received in response to results (e.g., results 420 (FIG. 4B)). In an example, the hypothetical change is any proposed or hypothetical change to a validated fuzzy causal graph. The change may involve adding, deleting, or modifying nodes or edges in the fuzzy causal graph. For instance, a user might propose replacing an existing technology node with a new one and updating the fuzzy causal edge to reflect a different level of influence.

In response to receiving the hypothetical change, the simulation system constructs (620) a temporary simulation graph. In an example, this is achieved by creating a copy of the current validated fuzzy causal graph then applying the hypothetical change to the copy. This approach ensures that the original, validated fuzzy causal graph remains unchanged, providing a safe environment for testing.

The simulation system may then identify (630) the parameters and success measures for the simulation. In this context, the parameters define the scenario to be tested and the conditions under which it will run, while the success measures specify how the outcome will be evaluated. Parameters can include, for example, the scope of the scenario (which nodes and edges are in play), the hypothesized modifications (e.g., replacing a technology node or changing an edge’s fuzzy strength), boundary conditions and assumptions (jurisdiction, environment, or timing qualifiers carried on edges), and execution settings such as the time horizon, traversal depth limits, or cycle-handling rules used during the evaluation of fuzzy relationships. Success measures, by contrast, are the decision criteria used to judge the result of the scenario once the simulation recomputes net influences using the computational method for determining net influence (minimum strength along each path, then maximum across parallel paths).

By way of example, success measures can include risk reduction, cost impact, and overall system quality. Although specific examples are given, other success measures may be used. Risk reduction can be operationalized by measuring how changes alter the net fuzzy influence of identified risk-bearing elements on critical assets or outcomes of concern.

In an example, the simulation can (a) enumerate relevant influence paths from risk sources to protected assets, (b) compute each path’s strength by taking the minimum fuzzy strength across its edges, (c) aggregate across parallel paths by taking the maximum, and then (d) compare the simulated net influence to the baseline to quantify the reduction (or increase) in risk. Cost impact can be represented as a separate measure tied to the proposed modifications (e.g., implementation, run-rate, or deprecation costs) and used alongside risk outcomes to evaluate trade-offs. Overall system quality can combine multiple effects-such as improvements to compliance coverage, resilience (e.g., reduced negative-polarity influence on reliability metrics), or performance-into a composite, with weights or thresholds defined up front as part of the success criteria.

In some examples, the simulation system may also record decision thresholds and rankings to support clear accept/reject outcomes. For instance, a scenario may be deemed successful if it achieves at least a specified reduction in net risk influence on a designated class of assets without exceeding a cost ceiling, or if it increases positive-polarity influence on a target capability to a required fuzzy level (e.g., from “much” to “a lot”). These parameters and measures together ensure that each scenario is run under explicit, repeatable conditions and is assessed against transparent criteria aligned to organizational priorities.

At operation 640 the simulation is executed on the temporary graph. To determine the new outcome, the simulation system recalculates the net influence across all paths affected by the modified nodes and edges. This is done by applying the computational method for evaluating fuzzy terms, which first involves identifying all paths affected by the change. For each path, the simulation system determines its new strength by taking the minimum fuzzy strength from all edges that constitute that path. The final net influence is then determined by taking the maximum strength from all parallel paths. This new state is then evaluated against the success measures defined in the prior step to quantify the impact of the change. Because the vocabulary order and operators do not change across scenarios, baseline and simulated results are directly comparable.

At operation 650 the simulation system generates and returns the simulation results. The results summarize the evaluated outcome of the hypothetical change, quantifying its impact against key success measures such as risk reduction, cost impact, and overall system quality. The results include a comparison against the original fuzzy causal graph's state to highlight the net effect, such as the change in net fuzzy influence on critical assets. If multiple scenarios were run, the system ranks the proposed changes by their effectiveness against these predefined measures and decision thresholds, allowing a user to select the optimal policy for implementation.

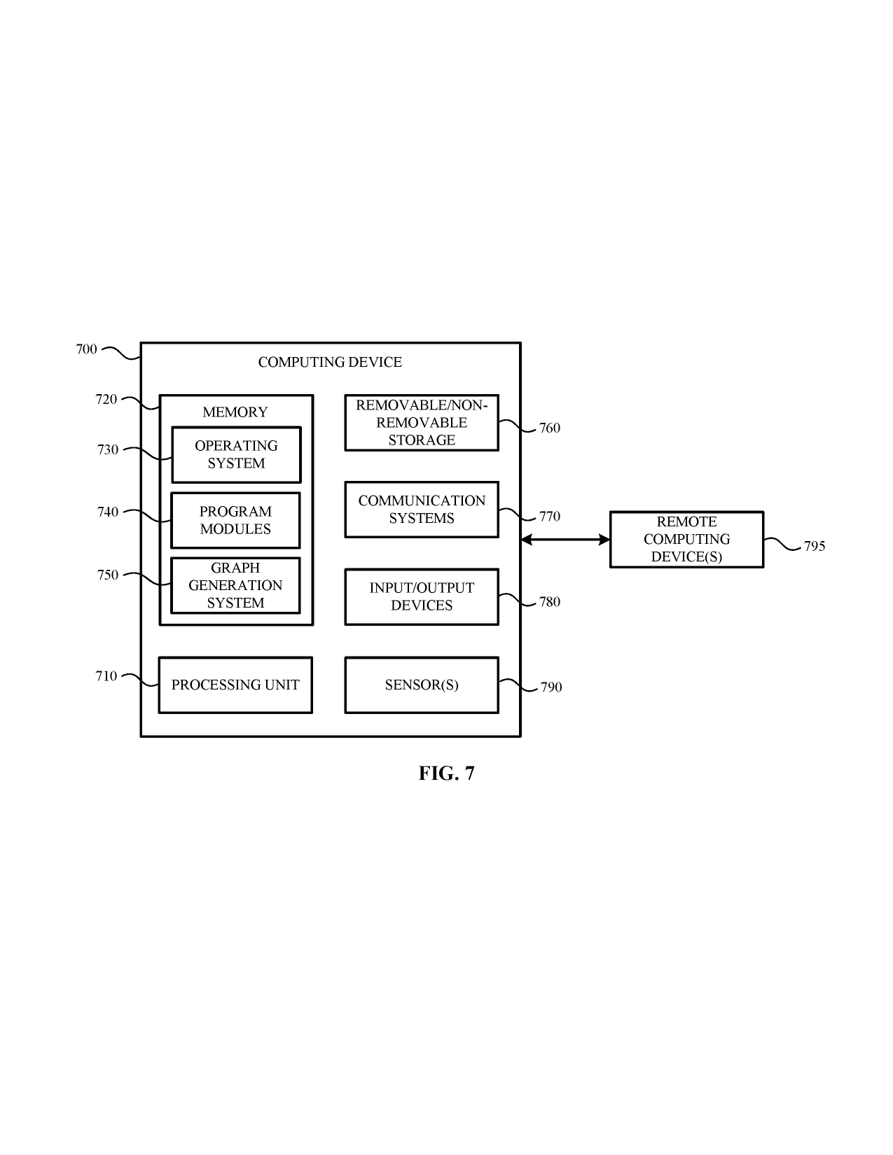

FIG. 7 illustrates various components and/or systems of a computing device 700 according to an example. In an example, the computing device 700, or various components and/or systems of the computing device 700, may be integrated or associated with the graph generation system 100 shown and described with respect to FIG. 1. In another example, the computing device 700 may be part of, or associated with one or more of the ingestion system 105, the artificial intelligence system 110, the storage system 115, the query system 120, the validation system 125, the simulation system 130, and/or the update system 135 shown and described with respect to FIG. 1. As shown in FIG. 7 , the physical components (e.g., hardware) of the computing device 700 are illustrated and these physical components may be used to practice the various aspects of the present disclosure.

In an example, the computing device 700 includes at least one processor or processing unit 710 and memory 720 (e.g., system memory). Although a single processing unit 710 is shown, the computing device 700 may include multiple processing units 710. Each of the processing units may work separately or together. The memory 720 may include, but is not limited to, volatile storage (e.g., random access memory), non-volatile storage (e.g., read-only memory), flash memory, or any combination of such memories. The memory 720 may also include an operating system 730. The operating system 730 controls the operation of the computing device 700 and one or more program modules 740 and/or the graph generation system 750.

The program modules 740 may be responsible for receiving input, issuing commands, providing output, and so on. As such, the graph generation system 750 may be responsible for performing the various operations described herein.

The computing device 700 may also have additional features or functionality. For example, the computing device 700 may include additional data storage devices (e.g., removable and/or non-removable storage devices 760) such as, for example, magnetic disks, optical disks, NAND/NOR memory devices, and the like.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 7 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 700 on the single integrated circuit (chip). The disclosure may also be practiced using other technologies capable of performing logical operations such as, for example, AND, OR, and NOT, including but not limited to mechanical, optical, fluidic, and quantum technologies.

The computing device 700 may include one or more communication systems 770 that enable the computing device 700 to communicate with remote computing devices 795 and/or systems. Examples of communication systems 770 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 700 may also have one or more input devices and/or one or more output devices shown as input/output devices 780. These input/output devices 780 may include a keyboard, a sound or voice input device, haptic devices, a touch, force and/or swipe input device, a display, speakers, etc. The aforementioned devices are examples and others may be used. The computing device 700 may also include various sensors 790 that are used to receive data and/or input.

The memory 720 and the removable/non-removable storage 760 are all computer storage media. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Accordingly, examples of the present disclosure describe a method, comprising: receiving, by a computer system, source information from one or more sources; generating, by an artificial intelligence system, a fuzzy causal graph from the source information, the fuzzy causal graph comprising a plurality of nodes representing concepts and a plurality of directed edges connecting the plurality of nodes, wherein each directed edge represents an influence and is labeled with a fuzzy term indicating a strength of the influence; storing the fuzzy causal graph in a storage system; and in response to receiving a query, executing the query on the fuzzy causal graph to determine a net influence between at least two nodes of the plurality of nodes. In an example, the method also includes validating the fuzzy causal graph using one or more deterministic checks prior to executing the query. In an example, validating the fuzzy causal graph comprises ensuring repeatable query integrity. In an example, executing the query comprises: enumerating one or more paths between the at least two nodes; for each of the one or more paths, determining a path strength by identifying a minimum fuzzy strength of all edges in the path; and determining the net influence by identifying a maximum path strength from the one or more paths. In an example, the method also includes receiving a hypothetical change to the fuzzy causal graph; applying the hypothetical change to generate a temporary simulation graph; and executing a simulation on the temporary simulation graph to evaluate an impact of the hypothetical change. In an example, the artificial intelligence system comprises a large language model. In an example, the source information comprises at least one of regulations, internal controls, or design documents. In an example, the fuzzy term is selected from a predefined vocabulary of terms.

Examples also describe a system, comprising: one or more processors; and a memory storing instructions that, when executed by the one or more processors, cause the system to perform operations comprising: receiving source information from one or more sources; generating, using an artificial intelligence system, a fuzzy causal graph from the source information, the fuzzy causal graph comprising a plurality of nodes representing concepts and a plurality of directed edges connecting the plurality of nodes, wherein each directed edge represents an influence and is labeled with a fuzzy term indicating a strength of the influence; storing the fuzzy causal graph; and in response to receiving a query, executing the query on the fuzzy causal graph to determine a net influence between at least two nodes of the plurality of nodes. In an example, the operations also include validating the fuzzy causal graph using one or more deterministic checks. In an example, executing the query comprises applying a computational method to the fuzzy terms to determine the net influence. In an example, applying the computational method comprises enumerating all paths between the at least two nodes, determining a minimum fuzzy strength for each path, and determining a maximum strength from all paths. In an example, the operations also include performing a simulation based on a hypothetical change to the fuzzy causal graph. In an example, generating the fuzzy causal graph comprises identifying the plurality of nodes by grouping concepts based on semantic similarity. In an example, generating the fuzzy causal graph comprises identifying the plurality of directed edges based on detecting influence cues in the source information.

Examples also describe a non-transitory computer-readable medium storing instructions that, when executed by one or more processors of a computer system, cause the computer system to perform operations, comprising: receiving source information from one or more sources; and generating, by an artificial intelligence system, a fuzzy causal graph from the source information, the fuzzy causal graph comprising a plurality of nodes representing concepts and a plurality of directed edges connecting the plurality of nodes, wherein each directed edge represents an influence and is labeled with a fuzzy term indicating a strength of the influence. In an example, the non-transitory computer-readable medium also includes instructions for validating the fuzzy causal graph to ensure it is a reliable model. In an example, the non-transitory computer-readable medium also includes instructions for executing a query on the fuzzy causal graph. In an example, the non-transitory computer-readable medium also includes instructions for: receiving a hypothetical change to the fuzzy causal graph; and executing a simulation based on the hypothetical change to evaluate an impact against one or more success measures. In an example, the one or more success measures include at least one of risk reduction or cost impact.

One of ordinary skill in the art will recognize that the technology described herein is not limited to a single specific memory structure, but covers many relevant memory structures within the spirit and scope of the technology as described herein and as understood by one of ordinary skill in the art.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as "first," "second," and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method, comprising:
receiving, by a computer system, source information from one or more sources;
generating, by an artificial intelligence system, a fuzzy causal graph from the source information, the fuzzy causal graph comprising a plurality of nodes representing concepts and a plurality of directed edges connecting the plurality of nodes, wherein each directed edge represents an influence and is labeled with a fuzzy term indicating a strength of the influence;
storing the fuzzy causal graph in a storage system; and
in response to receiving a query, executing the query on the fuzzy causal graph to determine a net influence between at least two nodes of the plurality of nodes.

2. The method of claim 1, further comprising validating the fuzzy causal graph using one or more deterministic checks prior to executing the query.

3. The method of claim 2, wherein validating the fuzzy causal graph comprises ensuring repeatable query integrity.

4. The method of claim 1, wherein executing the query comprises:
enumerating one or more paths between the at least two nodes;
for each of the one or more paths, determining a path strength by identifying a minimum fuzzy strength of all edges in the path; and
determining the net influence by identifying a maximum path strength from the one or more paths.

5. The method of claim 1, further comprising:
receiving a hypothetical change to the fuzzy causal graph;
applying the hypothetical change to generate a temporary simulation graph; and
executing a simulation on the temporary simulation graph to evaluate an impact of the hypothetical change.

6. The method of claim 1, wherein the artificial intelligence system comprises a large language model.

7. The method of claim 1, wherein the source information comprises at least one of regulations, internal controls, or design documents.

8. The method of claim 1, wherein the fuzzy term is selected from a predefined vocabulary of terms.

9. A system, comprising:
one or more processors; and
a memory storing instructions that, when executed by the one or more processors, cause the system to perform operations comprising:
receiving source information from one or more sources;
generating, using an artificial intelligence system, a fuzzy causal graph from the source information, the fuzzy causal graph comprising a plurality of nodes representing concepts and a plurality of directed edges connecting the plurality of nodes, wherein each directed edge represents an influence and is labeled with a fuzzy term indicating a strength of the influence;
storing the fuzzy causal graph; and
in response to receiving a query, executing the query on the fuzzy causal graph to determine a net influence between at least two nodes of the plurality of nodes.

10. The system of claim 9, the operations further comprising validating the fuzzy causal graph using one or more deterministic checks.

11. The system of claim 9, wherein executing the query comprises applying a computational method to the fuzzy terms to determine the net influence.

12. The system of claim 11, wherein applying the computational method comprises enumerating all paths between the at least two nodes, determining a minimum fuzzy strength for each path, and determining a maximum strength from all paths.

13. The system of claim 9, the operations further comprising performing a simulation based on a hypothetical change to the fuzzy causal graph.

14. The system of claim 9, wherein generating the fuzzy causal graph comprises identifying the plurality of nodes by grouping concepts based on semantic similarity.

15. The system of claim 9, wherein generating the fuzzy causal graph comprises identifying the plurality of directed edges based on detecting influence cues in the source information.

16. A non-transitory computer-readable medium storing instructions that, when executed by one or more processors of a computer system, cause the computer system to perform operations, comprising:
receiving source information from one or more sources; and
generating, by an artificial intelligence system, a fuzzy causal graph from the source information, the fuzzy causal graph comprising a plurality of nodes representing concepts and a plurality of directed edges connecting the plurality of nodes, wherein each directed edge represents an influence and is labeled with a fuzzy term indicating a strength of the influence.

17. The non-transitory computer-readable medium of claim 16, further comprising instructions for validating the fuzzy causal graph to ensure it is a reliable model.

18. The non-transitory computer-readable medium of claim 16, further comprising instructions for executing a query on the fuzzy causal graph.

19. The non-transitory computer-readable medium of claim 16, further comprising instructions for:
receiving a hypothetical change to the fuzzy causal graph; and
executing a simulation based on the hypothetical change to evaluate an impact against one or more success measures.

20. The non-transitory computer-readable medium of claim 19, wherein the one or more success measures include at least one of risk reduction or cost impact.
